(19) United States
(12) Patent Application Publication
(10) Pub. No.: US 2023/0409401 A1
(43) Pub. Date: Dec. 21, 2023

(54) PERFORMANCE RESOURCE AMOUNT INFORMATION MANAGEMENT APPARATUS, COMPUTER SYSTEM, AND PERFORMANCE RESOURCE AMOUNT INFORMATION MANAGEMENT METHOD

(71) Applicant: Hitachi, Ltd., Tokyo (JP)

(72) Inventors: Mitsuo Hayasaka, Tokyo (JP); Kazumasa Matsubara, Tokyo (JP); Akio Shimada, Tokyo (JP)

(73) Assignee: Hitachi, Ltd., Tokyo (JP)

(21) Appl. No.: 18/181,872

(22) Filed: Mar. 10, 2023

(30) Foreign Application Priority Data
Jun. 21, 2022 (JP) 2022-099585

(51) Int. Cl. G06F 9/50; G06F 11/34

(52) U.S. Cl. CPC G06F 9/5033; G06F 9/5044; G06F 11/3409

(57) ABSTRACT

A management node that manages performance resource amount information indicating a relationship between a resource amount of hardware allocated to software executed in a predetermined node and performance of the software includes a storage unit and a processor connected to the storage unit. The management node is configured to store a performance model management table in which a performance model is associated with an execution environment in which an application of a computing node is executed, in the storage unit, acquire operation information capable of specifying performance of the application executed in the execution environment, and modify the performance model corresponding to the execution environment based on the operation information.

### BACKGROUND OF THE INVENTION

### 1. Field of the Invention

The present invention relates to a technology related to modification of performance resource amount information indicating a relationship between a resource amount of hardware allocated to software and performance of the software.

### 2. Description of the Related Art

In the hybrid cloud, utilization is performed by using data stored in a distribution base. In order to perform data analysis in consideration of cost and performance in the distribution base, it is necessary for an analyst to set a resource amount to be allocated to an application (software) and to select a deployment destination base having extra resources, and man-hours are large.

Therefore, a function of automatically optimally arranging data and an application container between bases in consideration of performance and cost is required. In order to accurately perform the optimum arrangement, for example, it is necessary to create a performance model indicating a relationship between a resource allocation amount and the performance, calculate a resource amount required by the container according to an execution environment, and allocate the resources.

For example, a technique as follows is known (for example, see JP 2022-45666 A). For each distributed data store (application) executed on a data lake, a performance model indicating a relationship between an allocation amount of hardware (HW) resources and performance is created. When contention for HW resources occurs, the HW resource amount allocated to each distributed data store is automatically set based on the created performance model. The performance and the resource consumption are monitored. When a deviation between the performance model and actual performance is equal to or greater than a predetermined threshold value, the performance model is automatically modified based on a monitoring result.

### SUMMARY OF THE INVENTION

In JP 2022-45666 A, the performance model is created for an application (data store), and the allocation of HW resources is determined. However, even in the same application, if execution environments (for example, the type of base or CPU) of the application are different from each other, there is a concern that it is not possible to set an appropriate resource amount. In addition, in the execution environment, if the state of the execution environment changes due to device deterioration, device renewal, or the like, there is a concern that the created performance model does not appropriately correspond to the execution environment.

In addition, when the performance model is intended to be modified in order to calculate an accurate resource allocation amount, it is necessary to collect operation information of the application corresponding to the performance model. However, if the operation information is collected in order to modify the appropriate performance model, there is a concern that a load on a network in communication of the operation information, a processing load for storing the operation information, or the like occurs. In some cases, there is a concern that a neck occurs in collection of the operation information.

The present invention has been made in view of the above circumstances, and an object of the present invention is to provide a technique capable of easily and appropriately modifying performance resource amount information indicating a relationship between a resource amount of hardware allocated to software and performance of the software.

In order to achieve the above object, according to a first aspect, there is provided a performance resource amount information management apparatus that manages performance resource amount information indicating a relationship between a resource amount of hardware allocated to software executed by a predetermined node and performance of the software. The performance resource amount information management apparatus includes a storage unit, and a processor connected to the storage unit. The performance resource amount information is stored in the storage unit in association with an execution environment in which the software of the node is executed. The processor is configured to acquire operation information capable of specifying the performance of the software executed in the execution environment, and modify the performance resource amount information corresponding to the execution environment based on the operation information.

According to the present invention, it is possible to easily and appropriately modify the performance resource amount information indicating the relationship between the resource amount of the hardware allocated to the software and the performance of the software.

### BRIEF DESCRIPTION OF THE DRAWINGS

FIG. 1 is an overall configuration diagram illustrating a computer system according to a first embodiment;

FIG. 2 is a hardware configuration diagram illustrating the computer system according to the first embodiment;

FIG. 3 is a logical configuration diagram illustrating the computer system according to the first embodiment;

FIG. 4 is a diagram illustrating an outline of a performance model according to the first embodiment;

FIG. 5 is a configuration diagram illustrating a performance model management table according to the first embodiment;

FIG. 6 is a configuration diagram illustrating an operation information management table according to the first embodiment;

FIG. 7 is a diagram for explaining a method of modifying the performance model according to the first embodiment;

FIG. 8 is a diagram illustrating an example of a KPI registration screen according to the first embodiment;

FIG. 9 is a diagram illustrating an example of a setting input screen according to the first embodiment;

FIG. 10 is a configuration diagram illustrating a setting information management table according to the first embodiment;

FIG. 11 is a diagram illustrating a specific example of a resource allocation amount calculation method according to the first embodiment;

FIG. 12 is a flowchart illustrating a performance model difference check process according to the first embodiment;

FIG. 13 is a flowchart illustrating a performance model modification process according to the first embodiment;

FIG. 14 is a flowchart illustrating an operation information collection process according to the first embodiment;

FIG. 15 is a flowchart illustrating a performance model creation process according to the first embodiment;

FIG. 16 is a flowchart illustrating an application execution process according to the first embodiment;

FIG. 17 is a flowchart illustrating an application re-execution process according to the first embodiment;

FIG. 18 is a logical configuration diagram illustrating a computer system according to a second embodiment;

FIG. 19 is a configuration diagram illustrating an operation information management table according to the second embodiment; and

FIG. 20 is a flowchart illustrating a neck monitoring process according to the second embodiment.

### DESCRIPTION OF THE PREFERRED EMBODIMENTS

Embodiments will be described with reference to the drawings. The embodiments described below do not limit the invention according to the claims, and all the elements and combinations described in the embodiments are not necessarily essential for the solution of the invention.

In the following description, a process will be described with a “program” as an operation subject. The program is executed by a processor (for example, a central processing unit (CPU)) to execute a predetermined process while appropriately using a storage resource (for example, a memory) and/or a communication interface device (for example, a network interface card (NIC)). Thus, the processing subject may be set to the program. The process described with the program as the operation subject may be set to a process executed by a processor or a computer including the processor.

In the following description, information may be described with an expression of an “AAA table”, but the information may be expressed with any data structure. That is, the “AAA table” can be referred to as “AAA information” to indicate that the information does not depend on the data structure.

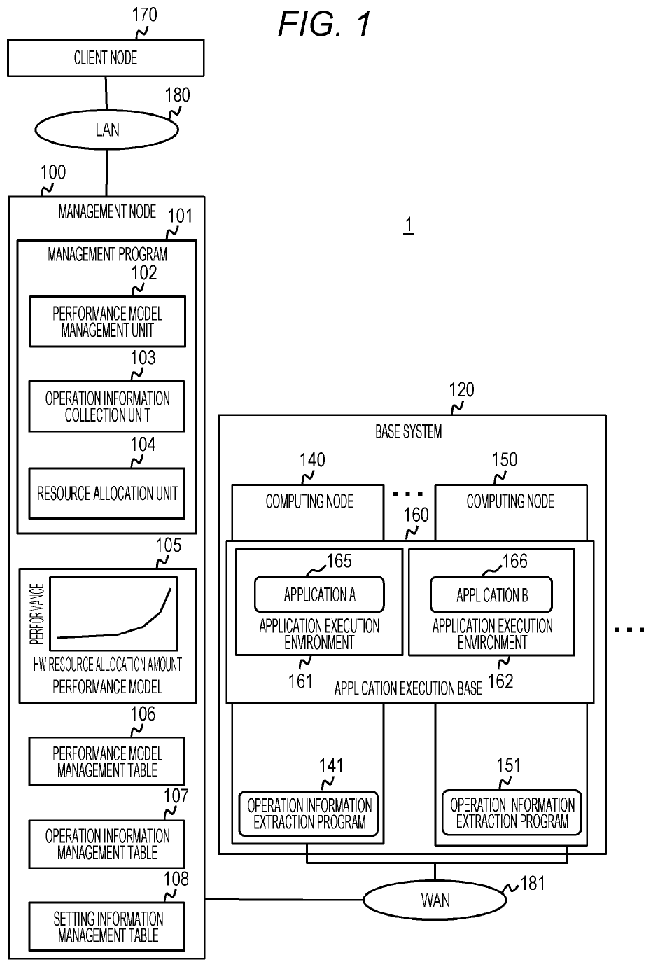

FIG. 1 is an overall configuration diagram illustrating a computer system according to a first embodiment.

A computer system 1 includes a management node 100 as an example of a performance resource amount information management apparatus, a base system 120, and a client node 170. The base system 120 includes one or more computing nodes 140 and 150. The number of base systems is not limited to one, and may be plural.

The management node 100 and the client node 170 are connected to each other via a network such as a local area network (LAN) 180, for example. The management node 100 is connected to the computing nodes 140 and 150 via a network such as a WAN 181, for example.

The computing nodes 140 and 150 cooperate (with a plurality of computing nodes) to constitute an application execution base 160. One or more application execution environments (application execution environments) 161,162 are constructed on the application execution base 160. An application 165 (application A) operates on the application execution environment 161, and an application 166 (application B) operates on the application execution environment 162. The computing nodes 140 and 150 execute operation information extraction programs 141 and 151. The operation information extraction programs 141 and 151 collect pieces of operation information of the computing nodes 140 and 150 and transfer the collected pieces of operation information to the management node 100 via the WAN 181. The number of computing nodes is two in FIG. 1, but may be one or three or more.

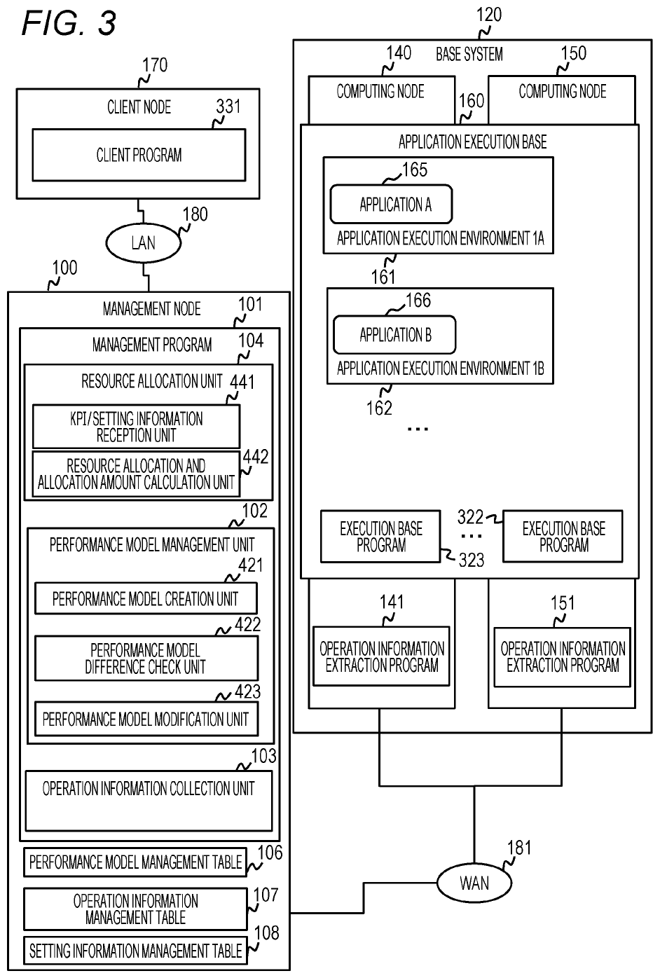

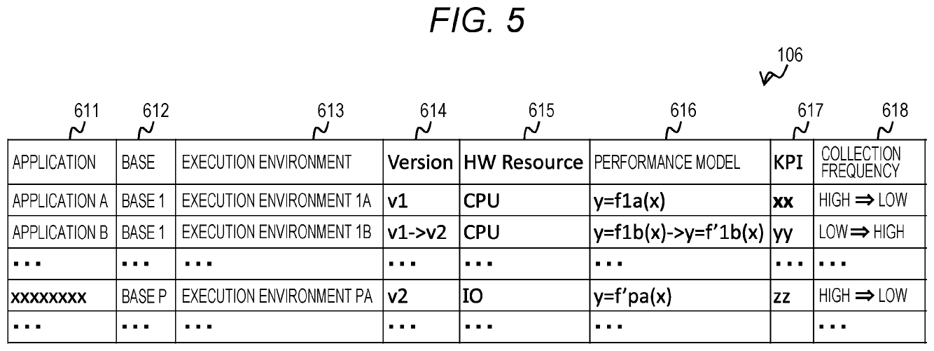

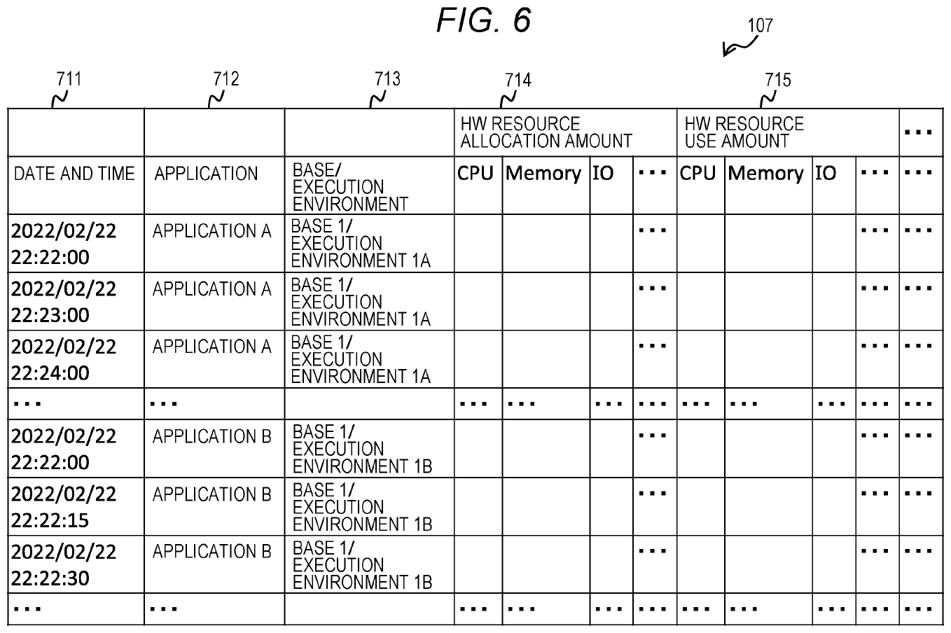

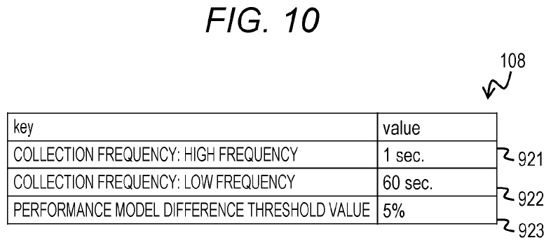

The management node 100 stores a management program 101, a performance model 105, a performance model management table 106 (see FIG. 5), an operation information management table 107 (see FIG. 6), and a setting information management table 108 (see FIG. 10). The management program 101 is executed by a CPU 242 (see FIG. 3) of the management node 100 to configure a performance model management unit 102, an operation information collection unit 103, and a resource allocation unit 104. The performance model management unit 102 cooperates with the performance model management table 106 to manage performance information and the like for hardware resources (referred to as HW resources below) for various applications. The operation information collection unit 103 collects operation information from an operation information extraction program 141 and the like on the computing node of each base and registers the operation information in the operation information management table 107. The resource allocation unit 104 constructs and re-constructs the application execution environment based on target performance and the necessary HW resource amount calculated by using the performance model 105, and controls execution and re-execution of the application.

The client node 170 receives, from an administrator, information (target performance information: for example, key performance indicator (KPI)) that is managed by the management node 100 and is capable of specifying the target performance for the applications 165 and 166 executed on the computing nodes, and various types of setting information. The client node 170 transmits the received information to the management node 100.

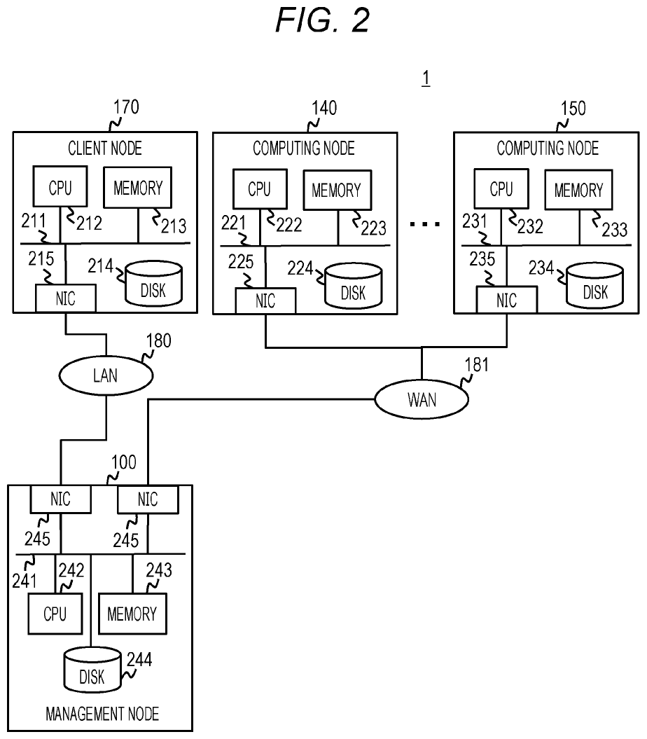

FIG. 2 is a hardware configuration diagram illustrating the computer system according to the first embodiment.

The management node 100 includes the CPU 242 as an example of the processor, a memory 243 as a main storage device, a disk device 244 as a secondary storage device, that is an example of a storage unit, and one or more NICs 245. The CPU 242, the memory 243, the disk device 244, and the NIC 245 are connected to each other via a bus 241.

The NIC 245 is an interface such as a wired LAN card or a wireless LAN card, for example, and communicates with other devices (for example, client node 170, computing nodes 140 and 150) via the LAN 180 and the WAN 181. The CPU 242 executes various processes in accordance with programs stored in the memory 243 and/or the disk device 244. The memory 243 is, for example, a RAM, and stores a program executed by the CPU 242 and necessary information. The disk device 244 is, for example, a hard disk drive (HDD) or a solid state drive (SSD), and stores a program executed by the CPU 242 and data used by the CPU 242.

The computing node 140 includes a CPU 222, a memory 223, a disk device 224, and an NIC 225. The CPU 222, the memory 223, the disk device 224, and the NIC 225 are connected to each other via a bus 221.

The computing node 150 includes a CPU 232, a memory 233, a disk device 234, and an NIC 235. The CPU 232, the memory 233, the disk device 234, and the NIC 235 are connected to each other via a bus 231.

The client node 170 includes a CPU 212, a memory 213, a disk device 214, and an NIC 215. The CPU 212, the memory 213, the disk device 214, and the NIC 215 are connected to each other via a bus 211.

FIG. 3 is a logical configuration diagram illustrating the computer system according to the first embodiment.

The client node 170 stores a client program 331. When executed by the CPU 212 of the client node 170, the client program 331 receives an input of target performance information (for example, KPI) from a user of the client node 170 and transmits the target performance information to the management node 100. When executed by the CPU 212 of the client node 170, the client program 331 receives inputs of various types of setting information from the user of the client node 170 and transmits the setting information to the management node 100.

The management node 100 stores the management program 101. When executed by the CPU 242 of the management node 100, the management program 101 configures the resource allocation unit 104, the performance model management unit 102, and the operation information collection unit 103.

The resource allocation unit 104 includes a KPI/setting information reception unit 441 and a resource allocation and allocation amount calculation unit 442. The KPI/setting information reception unit 441 receives the target performance information and the setting information from the client program 331 of the client node 170, stores the target performance information in the performance model management table 106, and stores the setting information in the setting information management table 108. The resource allocation and allocation amount calculation unit 442 calculates the allocation amount of the HW resources to the application based on performance model information and KPI information included in the performance model management table 106, sets the HW resource amount of the application execution environment, and causes the application to be executed.

The performance model management unit 102 includes a performance model creation unit 421, a performance model difference check unit 422, and a performance model modification unit 423. The performance model creation unit 421 measures the performance of the application in the application execution base 160 to create a performance model, and manages the performance model in the performance model management table 106. The performance model difference check unit 422 compares the performance information obtained from the performance model with performance information based on the operation information at the time of an actual operation in the actual execution environment of the application corresponding to the performance model, and checks whether there is a difference in performance. The performance model modification unit 423 modifies the performance model determined to have a difference in performance by the performance model difference check unit 422, based on the collected operation information.

The operation information collection unit 103 manages the operation information extraction program 141 and the like executed on the computing node of each base, instructs each operation information extraction program to collect the operation information regarding the computing node, the application execution base, the application execution environment, and the application, and collects the operation information. The operation information collection unit 103 stores the collected operation information in the operation information management table 107.

The computing node 140 stores an execution base program 323. The computing node 150 stores an execution base program 322.

The execution base program 323 executed by the CPU 222 of the computing node 140 and the execution base program 322 executed by the CPU 232 of the computing node 150 operate in cooperation with each other to constitute the application execution base 160. Although FIG. 3 illustrates an example in which the application execution base 160 is constituted by two computing nodes, the application execution base 160 may be constituted by any number of computing nodes.

In the application execution base 160, one or more application execution environments 161 and 162 to which the HW resources on the computing nodes are distributed are created. The application execution environments 161 and 162 may be, for example, any of a container, a virtual machine (VM), a process, and the like. The application execution environment includes the type of CPU to be used, the operation frequency of the CPU, and the like. The application 165 is executed in the application execution environment 161, and the application 166 is executed in the application execution environment 162. Although FIG. 3 illustrates one application that operates on one application execution environment, but two or more applications may operate on one application execution environment.

The operation information extraction programs 141 and 151 is executed by the CPUs to collect the pieces of operation information of the computing nodes 140 and 150 and transfer the collected pieces of operation information to the management node 100 via the WAN 181.

Here, creation of the performance model and registration of the performance model will be described.

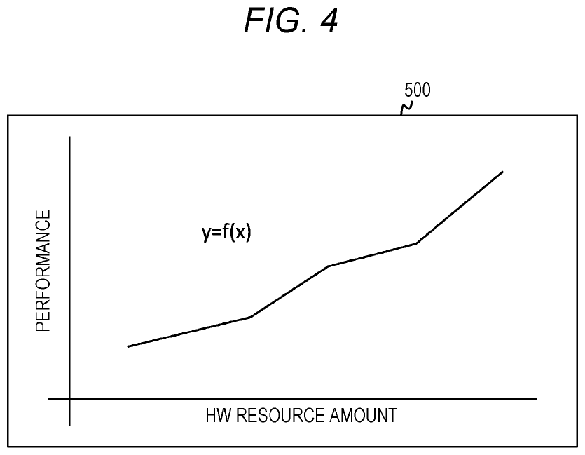

FIG. 4 is a diagram illustrating an outline of the performance model according to the first embodiment.

Regarding the creation of the performance model, for example, as illustrated in FIG. 4, a graph 500 of the application performance with respect to the change in the HW resource amount may be created, and an expression of an approximate curve of the graph, y=f(x), may be used as the performance model. Here, y indicates application performance per node, and x indicates an HW resource amount per node. y can be calculated by dividing a result of performance measurement (the overall performance of the application) by the performance model creation unit 421 by the number of computing nodes that execute the application. In other words, when y is multiplied by the number of nodes of the application, the overall performance of the application is obtained. The creation of the graph and the obtaining of the approximate curve expression in the creation of the performance model can be realized by using the known spreadsheet software, program, or the like.

FIG. 5 is a configuration diagram illustrating the performance model management table according to the first embodiment.

The performance model is registered in the performance model management table 106, for example. The performance model management table 106 stores an entry for each application to be executed, that is managed by the management node 100. When the applications to be executed are the same, but the execution environments in which the applications are executed are different, the performance model management table 106 stores entries corresponding to the respective applications.

The entry of the performance model management table 106 includes fields of an application 611, a base 612, an execution environment 613, Version 614, HW Resource 615, a performance model 616, KPI 617, and a collection frequency 618.

An application name corresponding to the entry is stored in the application 611. A base name in which the application corresponding to the entry is executed is stored in the base 612. An execution environment name of an execution environment in which the application corresponding to the entry is executed is stored in the execution environment 613. Information (version number) indicating the version of the performance model of the application corresponding to the entry is stored in Version 614. The version number is updated when the performance model of the application corresponding to the entry is modified. An HW resource targeted by the performance model corresponding to the entry is stored in HW Resource 615. A performance model of the application corresponding to the entry is stored in the performance model 616. When the performance model is modified, the modified performance model is stored in the performance model 616. The KPI designated for the application corresponding to the entry is stored in KPI 617. The HW resource amount to be allocated to the application is calculated based on the KPI in KPI 617 and the performance model in the performance model 616. Information on a collection frequency at which the operation information collection unit 103 collects the operation information from the application corresponding to the entry is stored in the collection frequency 618.

In the performance model management table 106, the performance model for the application is managed in association with the base where the application is executed and the execution environment where the application is executed. Thus, it is possible to allocate an appropriate resource in accordance with the base and the execution environment where the application is executed.

In the present embodiment, the mathematical expression is stored as the performance model, but for example, a plurality of sets of the HW resource amount and the corresponding measured performance may be recorded.

Next, the operation information management table 107 will be described.

FIG. 6 is a configuration diagram illustrating the operation information management table according to the first embodiment.

The operation information management table 107 stores an entry indicating the operation information for each application at a predetermined collection time point. The entry of the operation information management table 107 includes fields of a date and time 711, an application 712, a base/execution environment 713, an HW resource allocation amount 714, and an HW resource use amount 715.

The date and time when the operation information extraction program (141, 151, or the like) extracts information corresponding to the entry are stored in the date and time 711. An application name of an application corresponding to the information corresponding to the entry is stored in the application 712. A name of a base and an execution environment name of an execution environment in which the application corresponding to the entry is executed are stored in the base/execution environment 713. The resource amount of the HW (CPU, memory, IO, and the like) allocated to the application corresponding to the entry is stored in the HW resource allocation amount 714. The resource amount of the HW (CPU, memory, IO, and the like) used by the application corresponding to the entry is stored in the HW resource use amount 715.

Next, a method of modifying the performance model will be described.

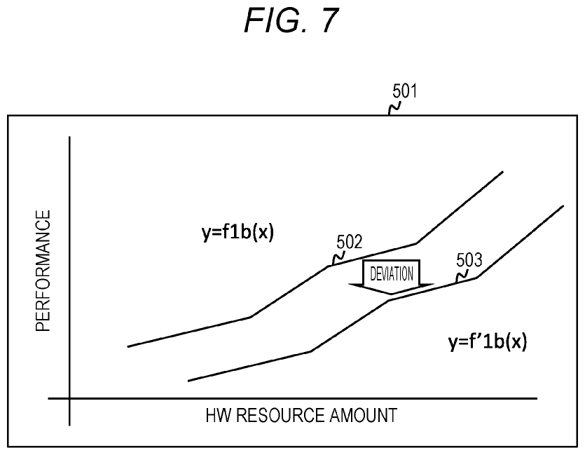

FIG. 7 is a diagram for explaining the method of modifying the performance model according to the first embodiment. FIG. 7 illustrates an example in which the HW resource is allocated to the application B executed in an execution environment 1B of the base 1 by an performance model 501 (y=f1b(x)).

The performance model difference check unit 422 specifies actual performance (actual performance) of each application based on the operation information of the operation information management table 107. Then, the performance model difference check unit 422 obtains a performance difference between the performance (assumed performance) calculated based on the performance model 501 used for allocating the HW resource to the application and the actual performance, and modifies the performance model 501 based on the performance difference to obtain a performance model 503 (y=f′1b(x)).

As a result, it is possible to create a performance model suitable for the base and the execution environment in which the application is actually executed, and thereafter, it is possible to appropriately allocate the HW resource to the application.

Next, a KPI registration screen 900 displayed on the client node 170 of the administrator by the KPI/setting information reception unit 441, for example, will be described.

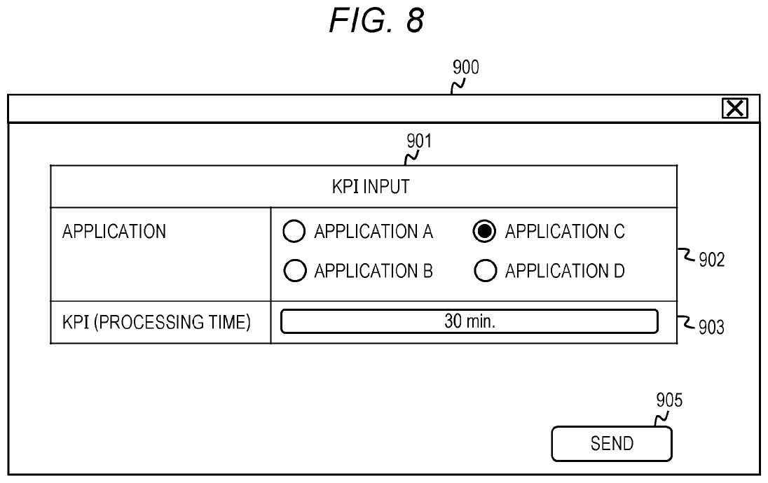

FIG. 8 is a diagram illustrating an example of the KPI registration screen according to the first embodiment.

The KPI registration screen 900 includes an input field 901 for inputting the KPI and a send button 905. The input field 901 includes an application selection field 902 and a KPI input field 903.

The application selection field 902 is a field for selecting an application as a KPI setting target. The KPI input field 903 is a field for inputting a KPI (in this example, processing time) to be set in the application.

The send button 905 is a button for receiving an instruction to transmit information input in the input field 901 to the management node 100. When the send button 905 is pressed, the client node 170 transmits the application selected in the application selection field 902 and the KPI input in the KPI input field 903 to the management node 100. As a result, in the management node 100, the KPI/setting information reception unit 441 receives the selected application and the input KPI, adds the entry of this application to the performance model management table 106, and stores the KPI input into KPI 617.

Next, a setting input screen 910 displayed on the client node 170 of the administrator by the KPI/setting information reception unit 441, for example, will be described.

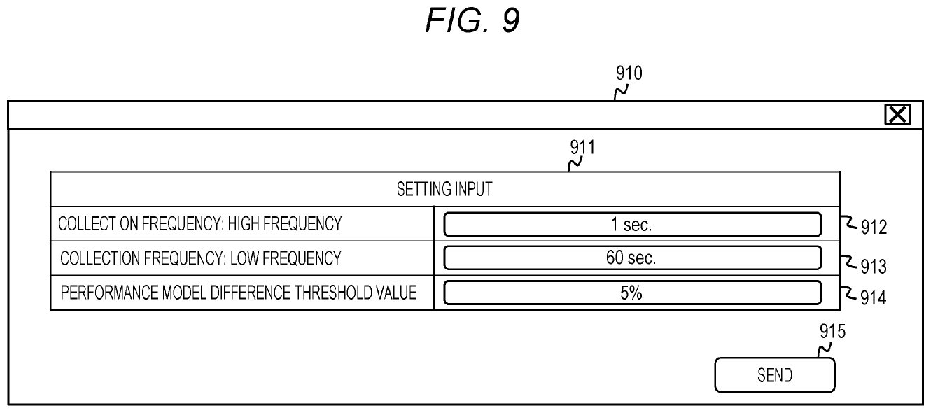

FIG. 9 is a diagram illustrating an example of the setting input screen according to the first embodiment.

The setting input screen 910 includes an input field 911 for inputting settings and a send button 915. The input field 911 includes a collection frequency: high frequency input field 912, a collection frequency: low frequency input field 913, and a performance model difference threshold-value input field 914.

The collection frequency: high frequency input field 912 is a field for inputting frequency information when the collection frequency of the operation information is set to a high frequency. The collection frequency: low frequency input field 913 is a field for inputting frequency information when the collection frequency of the operation information is set to a low frequency. The performance model difference threshold-value input field 914 is a field for inputting a threshold value for determining whether or not to modify the performance model.

The send button 915 is a button for receiving an instruction to transmit information input into the input field 911 to the management node 100. When the send button 915 is pressed, the client node 170 transmits the frequency input into the collection frequency: high frequency input field 912, the frequency input into the collection frequency: low frequency input field 913, and the threshold value input in the performance model difference threshold-value input field 914, to the management node 100. As a result, in the management node 100, the KPI/setting information reception unit 441 registers the frequency at the high frequency, the frequency at the low frequency, and the threshold value in the setting information management table 108.

Next, the setting information management table 108 will be described.

FIG. 10 is a configuration diagram illustrating the setting information management table according to the first embodiment.

The setting information management table 108 stores items of a collection frequency: high frequency 921, a collection frequency: low frequency 922, and a performance model difference threshold value 923. A frequency at which the operation information is collected at a high frequency, that is, a time interval at which the operation information is collected is stored in the collection frequency: high frequency 921. A frequency in a case where the operation information is collected at a low frequency, that is, a time interval at which the operation information is collected is stored in the collection frequency: low frequency 922. The time interval at the high frequency may be, for example, 1 second or 15 seconds, and the time interval at the low frequency may be, for example, 60 seconds. Threshold value information regarding a difference between performance based on the performance model when the performance model is modified and actual performance is stored in the performance model difference threshold value 923.

Next, a resource allocation amount calculation method of calculating an allocation amount of resources to an application by using the performance model will be described.

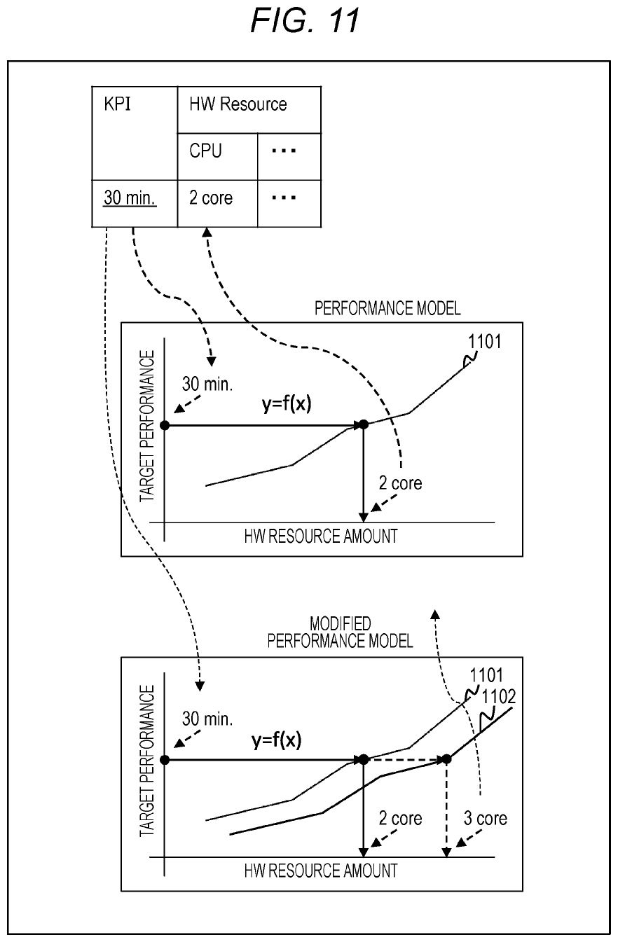

FIG. 11 is a diagram illustrating a specific example of the resource allocation amount calculation method according to the first embodiment.

Here, a description will be made on the assumption that 30 minutes (min) are input as the KPI (processing time) on the KPI registration screen 900 in the client node 170.

First, a performance model 1101 of an application to which resources are to be allocated is specified, and the HW resource amount when the target performance is 30 minutes is calculated based on the specified performance model 1101. In the example of FIG. 11, the performance model 1101 is a performance model related to the resource amount of the CPU, and the resource amount of the CPU for realizing the target performance is calculated to be two cores. When the performance model 1101 is modified to the performance model 1102, and the target performance is 30 minutes, the resource amount of the CPU for realizing the target performance is calculated to be three cores based on the performance model 1102.

Next, a performance model difference check process of checking a difference between the target performance and performance (actual performance) calculated based on the operation information and modifying the performance model in accordance with the check result will be described.

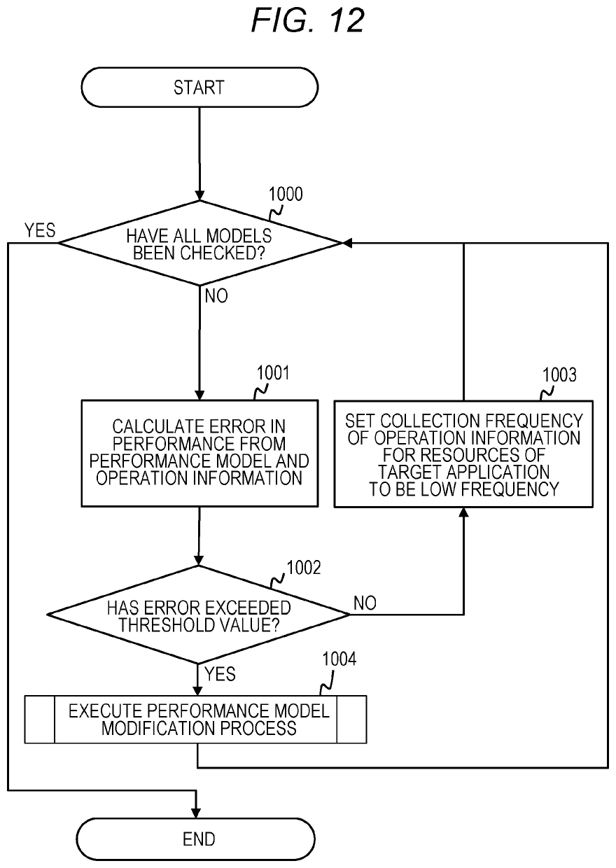

FIG. 12 is a flowchart illustrating the performance model difference check process according to the first embodiment.

The performance model difference check process is executed by the performance model difference check unit 422 of the management node 100 periodically or in response to an instruction or the like by the user, for example.

The performance model difference check unit 422 determines whether or not the difference between the target performance and the actual performance based on the operation information has been checked for all the performance models managed in the performance model management table 106 (Step 1000).

As a result, when it is determined that the difference between the target performance and the actual performance based on the operation information has been checked for all the performance models (Step 1000: Yes), the performance model difference check unit 422 ends the performance model difference check process.

On the other hand, when it is determined that the difference between the target performance and the actual performance based on the operation information has not been checked for all the performance models (Step 1000: No), the performance model difference check unit 422 calculates an error between the target performance and the actual performance obtained based on the operation information for the application of the performance model (target performance model) by using an unprocessed performance model as a processing target (Step 1001).

Then, the performance model difference check unit 422 determines whether or not the error between the target performance and the actual performance has exceeded a threshold value, based on the threshold information stored in the performance model difference threshold value 923 of the setting information management table 108 (Step 1002). As a result, when it is determined that the error between the target performance and the actual performance does not exceed the threshold value (Step 1002: No), it is not necessary to modify the performance model. Thus, the collection frequency 618 of the entry for the resource of the application corresponding to the target performance model in the performance model management table 106 is set to be a low frequency (Step 1003), and the process proceeds to Step 1000. Here, the low frequency may be, for example, a frequency at which the error between the actual performance and the target performance can be calculated.

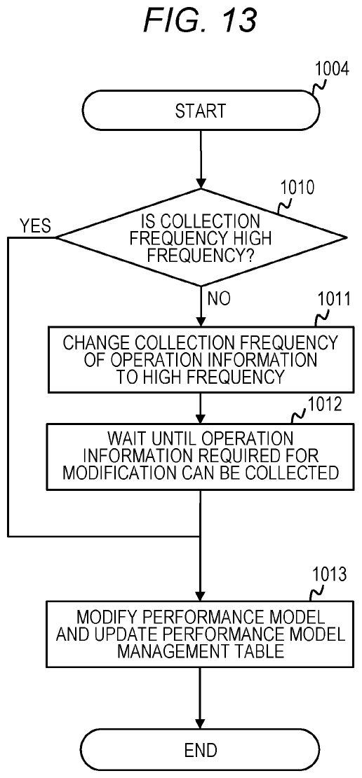

On the other hand, as a result, when it is determined that the error between the target performance and the actual performance has exceeded the threshold value (Step 1002: Yes), the performance model difference check unit 422 causes the performance model modification unit 423 to execute a performance model modification process (see FIG. 13) of modifying the target performance model (Step 1004). Then, the process proceeds to Step 1000.

According to the performance model difference check process, when the error between the target performance and the actual performance does not exceed the threshold value, the collection frequency of the operation information can be set to be a low frequency, and thus it is possible to reduce the load of a communication line for communication of the operation information and the communication process, and to reduce the load of the process of storing the operation information in the disk device.

Next, the performance model modification process in Step 1004 will be described.

FIG. 13 is a flowchart illustrating the performance model modification process according to the first embodiment.

The performance model modification unit 423 determines whether or not the collection frequency of the operation information on the application of the target performance model is a high frequency (Step 1010). Here, the high frequency may be, for example, a frequency at which the operation information necessary for modifying the performance model can be collected.

As a result, when it is determined that the collection frequency of the operation information on the application of the target performance model is a high frequency (Step 1010: Yes), the performance model modification unit 423 causes the process to proceed to Step 1013.

On the other hand, when it is determined that the collection frequency of the operation information on the application (target application) of the target performance model is not a high frequency (Step 1010: No), the performance model modification unit 423 changes the collection frequency 618 of the entry for the resource of the application corresponding to the target performance model in the performance model management table 106 to a high frequency (Step 1011), and waits until the operation information necessary for modifying the performance model can be collected (Step 1012). Then, the process proceeds to Step 1013.

In Step 1013, the performance model modification unit 423 modifies the target performance model based on the operation information, updates the performance model in the performance model 616 to the modified performance model in the entry corresponding to the target performance model of the performance model management table 106, updates the version in Version 614 to the next version, and ends the process. Here, as the method of modifying the target performance model based on the operation information, any method may be used as long as the method is a method of performing modification so that the error between the target performance and the actual performance calculated based on the operation information becomes small. For example, a performance model in which the performance of the target performance model with respect to each HW resource amount is adjusted by the error or a value based on the error may be used.

Next, an operation information collection process of collecting the operation information on the application executed in each base will be described.

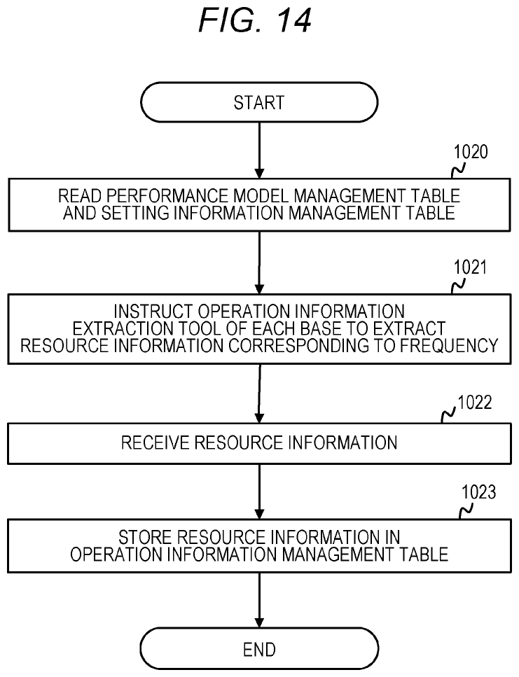

FIG. 14 is a flowchart illustrating the operation information collection process according to the first embodiment.

The operation information collection process is periodically executed by the operation information collection unit 103, for example.

The operation information collection unit 103 reads the information on each application (information in the application 611), the information on the base (information in the base 612), the information on the execution environment (information in the execution environment 613), and the information on the collection frequency (information in the collection frequency 618) from the performance model management table 106, and reads the high-frequency collection interval and the low frequency collection interval of the setting information management table 108 (Step 1020).

Then, the operation information collection unit 103 instructs the operation information extraction program (141, 151, or the like) of the computing node of each base system 120 to extract the operation information (in this example, resource information (information of an allocated HW resource and information of a used HW resource)) in accordance with the collection interval corresponding to each collection target (set of an application, a base, and an execution environment) (Step 1021). In a case where the collection target from which the operation information is extracted with a high frequency and the collection target from which the operation information is extracted with a low frequency are mixed in the same base, the operation information regarding the collection target from which the operation information is extracted with a low frequency is not extracted when the operation information is extracted with a high frequency.

Then, the operation information collection unit 103 receives the resource information extracted from the operation information extraction program of each base system 120 (Step 1022), registers the received resource information in the operation information management table 107 (Step 1023), and ends the process.

According to the operation information collection process, the operation information of each application executed in each execution environment of each base is stored in the operation information management table 107 in accordance with the set frequency.

Next, a performance model creation process of creating a performance model for an application will be described.

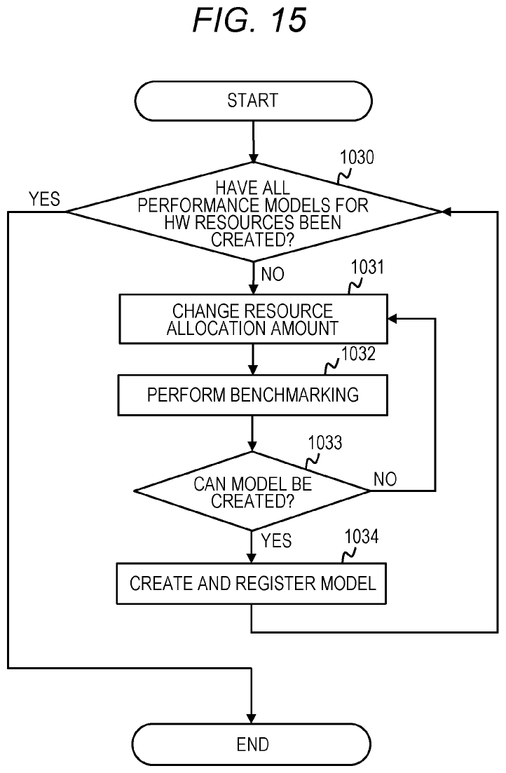

FIG. 15 is a flowchart illustrating the performance model creation process according to the first embodiment.

The performance model creation process is executed by the performance model creation unit 421, for example, when an instruction to register a new application (target application in the description of this process) is received from the user.

The performance model creation unit 421 determines whether or not a performance model indicating the relationship between the performance and the HW resource amount has been created for all the HW resources (for example, CPU, memory, IO unit, and the like) as a target for creating the performance model for the target application (Step 1030).

As a result, when the performance model has been created for all the HW resources for the target application (Step 1030: Yes), the performance model creation unit 421 ends the performance model creation process.

On the other hand, when the performance model has not been created for all the HW resources for the target application (Step 1030: No), the performance model creation unit 421 determines (changes) the resource allocation amount for the HW resource for which the performance model has not been created (Step 1031).

Then, the performance model creation unit 421 creates an application execution environment in which the HW resource of the determined resource allocation amount is allocated to the application execution base 160 of any base system 120, and executes the target application by the application execution environment to measure the performance of the target application (Step 1032). The base system 120 in which the target application is executed may be a base system in which the user causes the target application to be executed.

Then, the performance model creation unit 421 determines whether or not the performance model can be generated, specifically, whether or not the performance measurement is performed the number of times necessary to create the performance model (Step 1033).

As a result, when the measurement of the number of times necessary to create the application performance model has not been performed (Step 1033: No), the performance model creation unit 421 causes the process to proceed to Step 1031 and repeats the change of the resource allocation and the execution of the performance measurement of the application. The number of times of performance measurement to create the performance model and the change amount of the resource allocation amount to be changed for each performance measurement may be determined in advance.

On the other hand, when measurement has been performed the number of times necessary to create the performance model (Step 1033: Yes), the performance model creation unit 421 creates the performance model based on a plurality of measurement results, registers the created performance model in the performance model management table 106 (Step 1034), and causes the process to proceed to Step 1030. The performance model creation unit 421 may add a plurality of entries corresponding to each base for the target application to the performance model management table 106 and store the created performance model in the performance models 616 of the entries.

According to this performance model creation process, it is possible to create an initial performance model for each HW resource for the target application.

Next, an application execution process of creating an execution environment of an application and executing the application will be described.

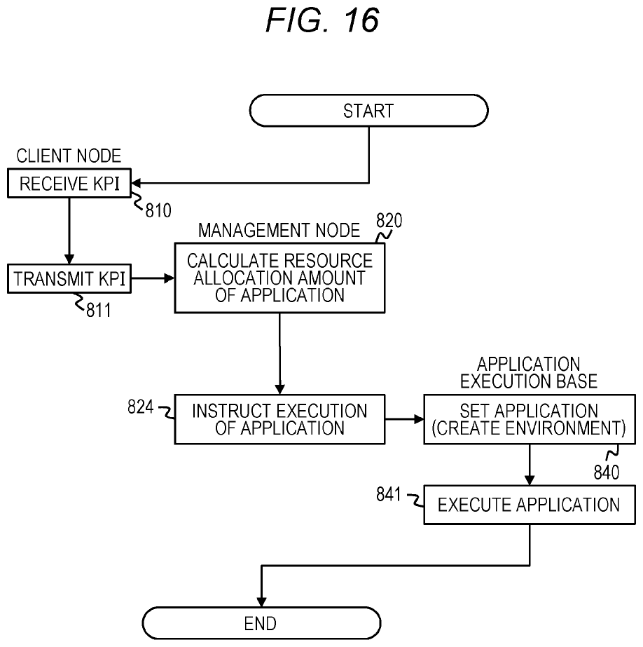

FIG. 16 is a flowchart illustrating the application execution process according to the first embodiment. The application execution process is started when there is an application execution request from the user in the client node 170.

The client program 331 of the client node 170 receives and displays the KPI registration screen 900 from the management node 100, and receives selection of an application to be executed and designation of a KPI for the application from the user (Step 810). Then, the client program 331 transmits the received application (in the description of this process, referred to as a target application) and the KPI (target performance) to the management node 100 (Step 811).

The resource allocation unit 104 in the management node 100 receives the target application and the target performance, refers to the performance model management table 106, specifies an entry corresponding to the target application and a predetermined base (for example, a base designated by the user or a base determined in accordance with a predetermined rule) in which the target application is executed, and calculates the resource amount to be allocated to the execution of the target application corresponding to the target performance based on the performance model of the entry (Step 820). The resource allocation unit 104 registers the received target performance in KPI 617 of the specified entry.

Then, the resource allocation unit 104 transmits information of the target application and information (resource amount information) of the resource amount to be allocated, to the application execution base 160 of the base system 120 in which the target application is executed, as an application execution instruction (Step 824).

The application execution base 160 creates an application execution environment in which the target application is executed, based on the received resource amount information (Step 840), and executes the target application on the created application execution environment (Step 841). The application execution base 160 notifies the resource allocation unit 104 in the management node 100 of the created application execution environment. The resource allocation unit 104 registers the identification information of the execution environment of which the notification has been received, in the execution environment 613 in the entry corresponding to the base and the target application of the performance model management table 106. Thus, the performance model in a certain execution environment of a certain base for the target application is managed in the performance model management table 106.

Next, an application re-execution process of changing the configuration of the execution environment of the application and re-executing the application will be described.

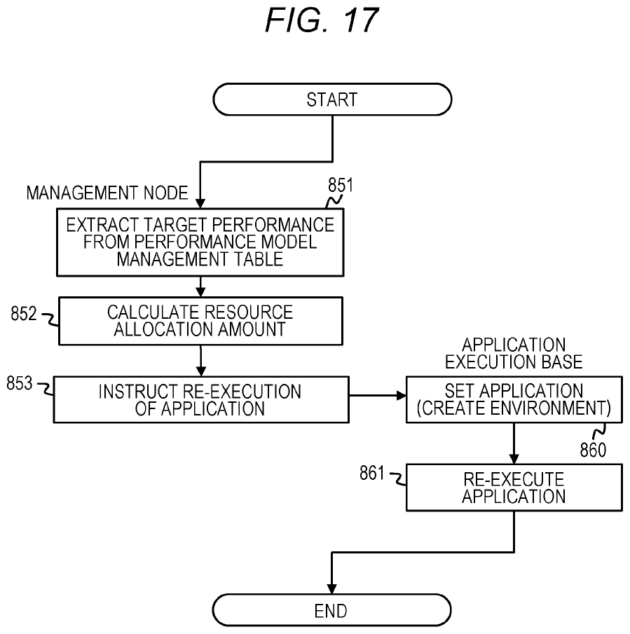

FIG. 17 is a flowchart illustrating the application re-execution process according to the first embodiment. The application re-execution process is executed, for example, when the resource allocation unit 104 detects that the performance model of the performance model management table 106 has been updated.

First, the resource allocation unit 104 specifies an entry in which the performance model has been updated from the performance model management table 106 and extracts the target performance from KPI 617 in the entry (Step 851). Then, the resource allocation unit 104 calculates the resource amount to be allocated to the execution of the target application corresponding to the target performance, based on the performance model of the entry (Step 852).

Then, the resource allocation unit 104 transmits information of the target application and information (resource amount information) of the resource amount to be allocated, to the application execution base 160 of the base system 120 in which the target application is executed, as an application re-execution instruction (Step 853).

The application execution base 160 re-creates an application execution environment in which the target application is executed, based on the received resource amount information (Step 860), and re-executes the target application on the created application execution environment (Step 861).

According to this application re-execution process, when the performance model has been updated, it is possible to calculate an appropriate resource amount to be allocated to the application by the updated performance model, and to re-execute the application with the execution environment of the application as the appropriate resource amount.

Next, a computer system 1A according to a second embodiment will be described.

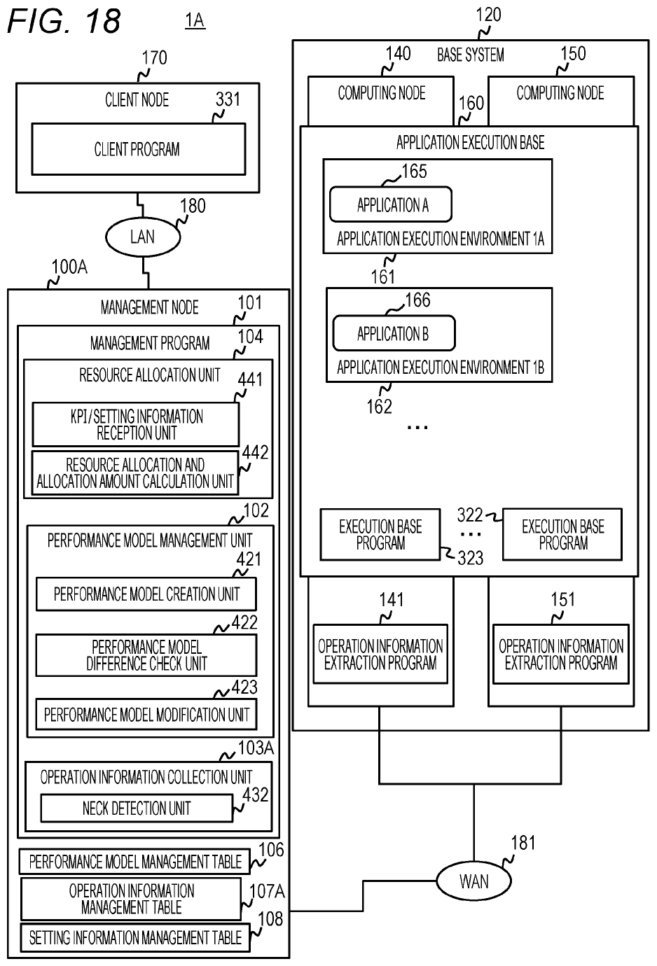

FIG. 18 is a logical configuration diagram illustrating the computer system according to the second embodiment. In the computer system 1A according to the second embodiment, the same components as those of the computer system 1 are denoted by the same reference numerals.

The computer system 1A includes an operation information collection unit 103A instead of the operation information collection unit 103 in the computer system 1, and an operation information management table 107A instead of the operation information management table 107.

The operation information collection unit 103A manages the operation information extraction program (141, 151, or the like) executed on the computing node of each base, instructs each operation information extraction program to collect the computing node, the application execution base, the application execution environment, and the operation information of the application, and collects the information in the operation information management table 107A. The operation information collection unit 103A stores, in the operation information management table 107A, error information regarding the collection of the operation information, such as a collection timeout of the operation information when the operation information is collected and a timeout when data is written to the operation information management table 107A.

The operation information collection unit 103A further includes a neck detection unit 432. The neck detection unit 432 detects whether or not a neck related to communication of the operation information, a neck related to storage of the operation information, or the like has occurred, based on the error information regarding the collection of the operation information in the operation information management table 107A.

Next, the operation information management table 107A will be described.

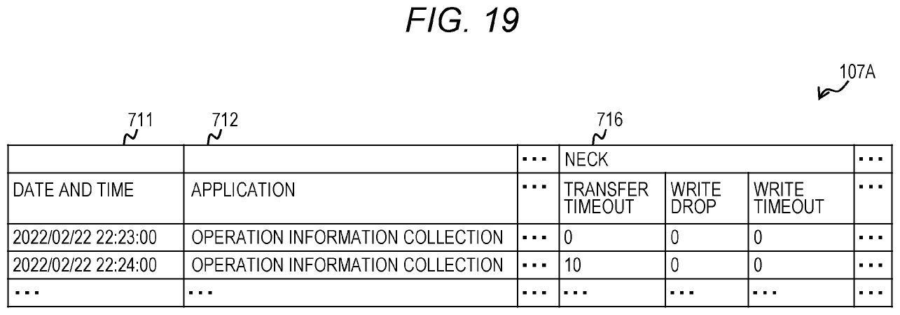

FIG. 19 is a configuration diagram illustrating the operation information management table according to the second embodiment.

The operation information management table 107A stores an entry of information regarding an error at the time of collecting the operation information in addition to the entry stored in the operation information management table 107. The entry of the information regarding the error includes a date and time 711, an application 712, and a neck 716. The date and time when the error is detected is stored in the date and time 711. An application name of an application of for collecting the operation information is stored in the application 712. The number of transfer timeouts occurring at the time of transfer of the operation information, the number of write dropouts in which the operation information cannot be written in the operation information management table 107A, and the number of write timeouts occurring at the time of writing the operation information are stored in the neck 716.

In the initial state, the operation information collection unit 103A in the management node 100 according to the present embodiment collects the operation information regarding each application being executed at a high frequency, and the performance model modification unit 423 executes the performance model modification process as appropriate. As a result, it is possible to modify the performance model to a performance model appropriate to the actual execution environment for each application, and to applicate an appropriate resource amount necessary for realizing the target performance to the application.

In such process, it is important to collect the operation information at a high frequency. However, when the number of applications from which the operation information is collected increases, there is a probability that the collection of the operation information is delayed and the performance model cannot be appropriately modified. Therefore, in the present embodiment, a neck monitoring process is performed.

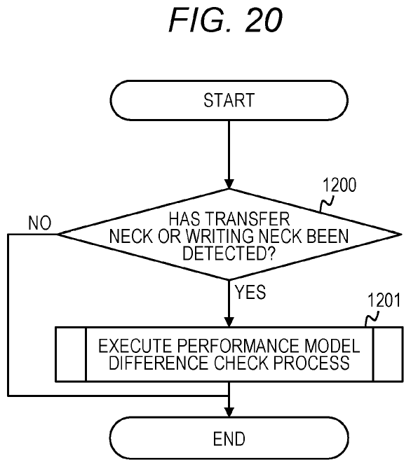

FIG. 20 is a flowchart illustrating the neck monitoring process according to the second embodiment.

The neck monitoring process is executed by the neck detection unit 432, for example, periodically or when an instruction from the user is received.

The neck detection unit 432 refers to the operation information management table 107A to determine whether or not the occurrence of the transfer neck or the writing neck has been detected regarding the collection of the operation information (Step 1200). Here, for example, when the number of times of transfer timeout or write timeout occurring within a predetermined time is equal to or more than a predetermined value, it may be determined that the transfer neck or the writing neck has occurred.

As a result, when it is determined that the occurrence of the transfer neck or the writing neck has not been detected (Step 1200: No), it means that the frequency of the operation information does not need to be changed, and thus, the neck detection unit 432 ends the neck monitoring process.

On the other hand, when it is determined that the occurrence of the transfer neck or the writing neck has been detected (Step 1200: Yes), the performance model difference check process (see FIG. 12) is executed (Step 1201), and the process is ended. According to the performance model difference check process, as described above, when the error between the target performance and the actual performance does not exceed the threshold value, the operation information is collected at a low frequency, so that it is possible to avoid the occurrence of the neck.

According to the present embodiment, when the neck does not occur in the collection of the operation information, it is possible to modify the performance model by collecting the operation information at a high frequency. In addition, when the neck occurs, it is possible to avoid the occurrence of the neck.

The present invention is not limited to the above-described embodiments, and can be appropriately modified and implemented in a range without departing from the gist of the present invention.

For example, in the above embodiments, a mathematical expression is used as the performance model, but the present invention is not limited thereto. For example, an inference model that outputs a necessary HW resource amount by using performance as an input, the model being learned by machine learning, may be used.

In the second embodiment, the performance model difference check process is executed when the occurrence of the neck is detected. However, the present invention is not limited to this. For example, when the neck is not necessarily generated, but the communication load is equal to or higher than a predetermined value or a predetermined number or more of writing errors occur, the performance model difference check process may be executed.

In the above embodiments, some or all of the processes executed by the CPU may be executed by a hardware circuit. The program in the above embodiments may be installed from a program source. The program source may be a program distribution server or a recording medium (for example, a portable recording medium).

What is claimed is:

1. A performance resource amount information management apparatus that manages performance resource amount information indicating a relationship between a resource amount of hardware allocated to software executed by a predetermined node and performance of the software, the performance resource amount information management apparatus comprising:
a storage unit; and
a processor connected to the storage unit,
wherein
the performance resource amount information is stored in the storage unit in association with an execution environment in which the software of the node is executed, and
the processor is configured to
acquire operation information capable of specifying the performance of the software executed in the execution environment, and
modify the performance resource amount information corresponding to the execution environment based on the operation information.

2. The performance resource amount information management apparatus according to claim 1, wherein
the processor is further configured to
determine whether a performance difference between actual performance of the software specified by the operation information and the performance of the software based on the performance resource amount information corresponding to the execution environment is equal to or more than a predetermined threshold value, and
modify the performance resource amount information corresponding to the execution environment based on the operation information when the performance difference is equal to or more than the threshold value.

3. The performance resource amount information management apparatus according to claim 2, wherein
the processor is further configured to
when the performance difference is not equal to or more than the threshold value, set a collection frequency of the operation information of the software executed in the execution environment, to a low frequency, and
when the performance difference is equal to or more than the threshold value, set the collection frequency of the operation information of the software executed in the execution environment, to a high frequency.

4. The performance resource amount information management apparatus according to claim 3, wherein
the processor is further configured to receive information indicating the low frequency and the high frequency.

5. The performance resource amount information management apparatus according to claim 1, wherein
the processor is further configured to
acquire operation information capable of specifying the performance of the software executed in the execution environment at a predetermined frequency,
determine whether or not a predetermined situation has occurred in the acquisition of the operation information, and
when the predetermined situation has occurred, determine whether or not a performance difference between actual performance of the software specified by the operation information and the performance of the software based on the performance resource amount information corresponding to the execution environment is equal to or more than a predetermined threshold value.

6. The performance resource amount information management apparatus according to claim 5, wherein
the predetermined situation includes a case where a neck has occurred in transfer of the operation information or a neck has occurred in storage of the operation information.

7. The performance resource amount information management apparatus according to claim 1, wherein
the processor is further configured to, when the performance resource amount information is modified,
determine a resource amount of hardware allocated to the software based on the performance resource amount information, and
set hardware of the determined resource amount to be allocated to the software.

8. The performance resource amount information management apparatus according to claim 1, wherein
the performance resource amount information is a performance model capable of obtaining a resource amount of the hardware capable of realizing the performance, from performance capable of being realized by the software.

9. The performance resource amount information management apparatus according to claim 2, wherein
the processor is further configured to receive the threshold value.

10. A computer system comprising:
one or more nodes that execute software; and
a performance resource amount information management apparatus that manages performance resource amount information indicating a relationship between a resource amount of hardware allocated to software executed by the nodes and performance of the software, wherein
the performance resource amount information management apparatus
stores the performance resource amount information in a storage unit in association with an execution environment in which the software of the node is executed,
acquires operation information capable of specifying the performance of the software executed in the execution environment from the node,
determines whether or not a performance difference between actual performance of the software specified by the operation information and the performance of the software based on the performance resource amount information corresponding to the execution environment is equal to or more than a predetermined value,
modifies the performance resource amount information corresponding to the execution environment based on the operation information when the performance difference is equal to or more than the predetermined value,
determines a resource amount of the hardware to be allocated to the software based on the performance resource amount information when the performance resource amount information is modified, and
set the node so that hardware of the determined resource amount is allocated to the software.

11. A performance resource amount information management method by a performance resource amount information management apparatus that manages performance resource amount information indicating a relationship between a resource amount of hardware allocated to software executed in a predetermined node and performance of the software, the performance resource amount information management method comprising:
by the performance resource amount information management apparatus,
storing the performance resource amount information in a storage unit in association with an execution environment in which the software of the node is executed;
acquiring operation information capable of specifying performance of the software executed in the execution environment;
determining whether or not a performance difference between actual performance of the software specified by the operation information and the performance of the software based on the performance resource amount information corresponding to the execution environment is equal to or more than a predetermined value; and
modifying the performance resource amount information corresponding to the execution environment based on the operation information when the performance difference is equal to or more than the predetermined value.
